(19) United States
(12) Patent Application Publication
(10) Pub. No.: US 2026/0290081 A1
(43) Pub. Date: Sep. 24, 2026

(54) MACHINE LEARNING BASED SYSTEM AND METHOD FOR OPTIMIZED REAL-TIME IDENTITY VERIFICATION OF USERS ON EDGE DEVICES

(71) Applicant: Sanjay Krishnamurthy, Cupertino, CA (US)

(72) Inventor: Sanjay Krishnamurthy, Cupertino, CA (US)

(21) Appl. No.: 19/557,375

(22) Filed: Mar. 5, 2026

Related U.S. Application Data
(60) Provisional application No. 63/768,001, filed on Mar. 6, 2025.

(51) Int. Cl. G06V 40/40; G06Q 20/40; G06V 10/74; G06V 10/764; G06V 10/82; G06V 10/94; G06V 40/16; G10L 17/22; G10L 25/24

(52) U.S. Cl. CPC G06V 40/45; G06Q 20/4016; G06V 10/761; G06V 10/764; G06V 10/82; G06V 10/95; G06V 40/169; G06V 40/171; G06V 40/172; G10L 17/22; G10L 25/24

(57) ABSTRACT

A machine learning (ML)-based method and system for optimized real-time identity verification of users on edge devices, is disclosed. The process begins by obtaining first inputs associated with users through image capturing units of the edge devices, using SDK configuring on the edge devices. The process is followed by generating first embeddings from the first inputs using feature extraction models executing on the edge devices. The process includes performing at least one of: liveness detection and deepfake detection on the edge devices based on the generated first embeddings, using a ML-based classifier executing on the edge devices. The first embeddings are stored in secured local storage of edge devices.

### CROSS-REFERENCES TO RELATED APPLICATIONS

This application claims the priority to and incorporates by reference the entire disclosure of U.S. provisional patent application bearing No. 63/768,001 filed on Mar. 6, 2025.

### FIELD OF INVENTION

Embodiments of the present disclosure relate to machine learning (ML)-based systems, and more particularly relates to a ML-based method and system for optimized real-time identity verification of one or more users, in one or more modalities such as audios, images, and videos, on one or more edge devices.

### BACKGROUND

Know-your-customer (KYC) and identity verification processes are widely used in financial services, government platforms, telecommunications, healthcare, and digital commerce to comply with regulatory requirements, prevent fraud, and establish trust between service providers and users.

Conventional KYC solutions commonly rely on server-centric architectures, in which identity verification tasks are primarily executed on centralized backend infrastructure. A typical video KYC workflow involves one or more of the following steps: (a) a user participates in a live video call with a trained verification agent or records a selfie video while speaking a prescribed passphrase, (b) facial images and government-issued identity documents are captured via a client application, (c) the captured images, audio, or full video streams are transmitted over a network to remote servers, and (d) backend systems perform facial recognition, document verification, liveness detection, and fraud analysis using server-side compute resources.

While the above said approaches are widely deployed, the existing solutions exhibit several technical and operational limitations. The server-based KYC systems require reliable, high-bandwidth internet connectivity to transmit raw or lightly processed biometric data. In regions with unstable networks or during high-latency conditions, this dependence can lead to failed verifications, poor user experience, and increased abandonment rates. Transmitting full-resolution facial images, audio recordings, and identity documents to centralized servers increases the attack surface for data breaches. The storage of raw biometric data on servers also raises regulatory and compliance concerns under data-protection frameworks such as GDPR and similar privacy regimes. Existing systems often do not minimize data exposure at the source.

The centralized processing of video, audio, and image data is computationally expensive. As user volumes increase, backend infrastructure must scale accordingly, leading to higher operational costs, increased latency during peak loads, and complex capacity planning. The modern edge devices such as smartphones, tablets, and browsers, are equipped with powerful processors, secure enclaves, and on-device machine-learning accelerators. Traditional KYC solutions underutilize these capabilities, relegating most verification tasks to the server even when they could be performed locally with lower latency and improved privacy.

Recent advances in generative artificial intelligence have made it increasingly feasible to produce high-quality synthetic images, videos, and cloned audio. Many existing KYC systems rely on single-modality checks or server-side analysis that may not adequately detect sophisticated deepfake or replay attacks, particularly when attackers attempt repeated submissions at scale. In conventional systems, users are often required to repeat full KYC or biometric capture flows for high-risk actions such as account recovery or large transactions. This results in redundant data transmission, higher verification latency, and degraded user experience.

Hence, there is a need for an improved machine learning (ML)-based system and method for optimized real-time identity verification of one or more users, in one or more modalities such as audios, images, and videos, on one or more edge devices, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine learning (ML)-based method for optimized real-time identity verification of one or more users on one or more edge devices, is disclosed. The ML-based method comprises obtaining, by one or more hardware processors, one or more first inputs associated with the one or more users through one or more image capturing units of the one or more edge devices, using a software development kit configuring on the one or more edge devices.

The ML-based method further comprises generating, by the one or more hardware processors, one or more first embeddings from the one or more first inputs associated with the one or more users, using one or more feature extraction models executing on the one or more edge devices. In an embodiment, raw biometric data from which the one or more first embeddings are generated is processed entirely on the one or more edge devices and is not transmitted externally from the one or more edge devices.

The ML-based method further comprises performing, by the one or more hardware processors, at least one of: liveness detection and deepfake detection, on the one or more edge devices based on the generated one or more first embeddings, using a ML-based classifier executing on the one or more edge devices.

The ML-based method further comprises storing, by the one or more hardware processors, the generated one or more first embeddings in a secured local storage of the one or more edge devices.

In an embodiment, the ML-based method further comprises: (a) extracting, by the one or more hardware processors, one or more second embeddings from at least one reference image associated with one or more pre-authorized identities of the one or more users; (b) performing, by the one or more hardware processors, a cosine similarity matching between the generated one or more first embeddings and the one or more second embeddings by computing a cosine similarity score representing a degree of similarity between the one or more first embeddings and the one or more second embeddings; and (c) validating, by the one or more hardware processors, the one or more users when the cosine similarity score exceeds a configurable threshold value, and permitting the one or more users to retry obtaining the one or more first inputs for a pre-configured maximum number of attempts when the cosine similarity score does not exceed the configurable threshold value.

In another embodiment, the ML-based method further comprises: (a) analyzing, by the one or more hardware processors, whether the one or more users initiate one or more high-risk transactions upon validation of the one or more users into a ML-based system; (b) requesting, by the one or more hardware processors, one or more second inputs associated with the one or more users from the one or more edge devices of the one or more users, using the software development kit for re-authentication; (c) generating, by the one or more hardware processors, one or more third embeddings from the one or more second inputs associated with the one or more users, using the one or more feature extraction models; (d) comparing, by the one or more hardware processors, the generated one or more third embeddings with the generated one or more first embeddings stored in the secured local storage of the one or more edge devices; (e) comparing, by the one or more hardware processors, the generated one or more third embeddings with the generated one or more first embeddings; and (f) validating, by the one or more hardware processors, the one or more users to perform the transaction data associated with the one or more high-risk transactions when the generated one or more third embeddings are matched with the generated one or more first embeddings.

In yet another embodiment, generating the one or more first embeddings comprising one or more image-based embeddings using the one or more feature extraction models, comprises: (a) extracting, by the one or more hardware processors, one or more still frames from one or more videos of the one or more users; (b) processing, by the one or more hardware processors, the extracted one or more still frames to analyze one or more visual features of the one or more still frames comprising facial structure, facial features and facial patterns, using a contrastive language-image pre-training based feature extraction model by: receiving, by the one or more hardware processors, the one or more still frames extracted from the one or more videos of the one or more users, pre-processing, by the one or more hardware processors, the one or more still frames by resizing and normalizing one or more pixel values of the one or more still frames to a standard format, applying, by the one or more hardware processors, the pre-processed one or more still frames to extract one or more hierarchical visual features through a neural network encoder, wherein the one or more hierarchical visual features comprise at least one of: low-level visual features comprising edges, textures, and color gradients, mid-level visual features comprising facial contours, eye shapes, and nose structure, and high-level visual features comprising overall facial geometry, and unique identifying patterns, and mapping, by the one or more hardware processors, the extracted one or more hierarchical visual features into a shared embedding space where similar still frames are positioned in relative proximity; and (c) outputting, by the one or more hardware processors, a pre-determined size of element floating point vector indicating a unique signature of the one or more still frames.

In yet another embodiment, generating the one or more first embeddings comprising the one or more audio-based embeddings using the one or more feature extraction models, comprises: (a) extracting, by the one or more hardware processors, one or more audio segments from one or more passphrases spoken by one or more users during the one or more videos; (b) processing, by the one or more hardware processors, the extracted one or more audio segments to analyze one or more audio characteristics of the one or more audio segments comprising voice patterns, speech features, and vocal signatures, using a deep representation learning based feature extraction model by: receiving, by the one or more hardware processors, the one or more audio segments extracted from the one or more passphrases spoken by one or more users during the one or more videos, pre-processing, by the one or more hardware processors, the one or more audio segments by converting raw audio waveform into spectral data comprising at least one of: mel-frequency cepstral coefficients or spectrograms, applying, by the one or more hardware processors, the spectral data to extract one or more hierarchical audio features through a neural network encoder, wherein the one or more hierarchical audio features comprise at least one of: low-level audio features comprising pitch, tone, and frequency patterns, mid-level audio features comprising phoneme characteristics, speech rhythm, and cadence, and high-level audio features comprising speaker-specific vocal signatures, and unique voice patterns, and mapping, by the one or more hardware processors, the extracted one or more hierarchical audio features into a shared embedding space where similar voices are positioned in relative proximity; and (c) outputting, by the one or more hardware processors, a pre-determined size of element floating point vector indicating a unique signature of the one or more audio segments.

In yet another embodiment, determining whether the one or more users are the one or more live users based on the generated one or more first embeddings, using the ML-based classifier, comprises: (a) receiving, by the one or more hardware processors, the one or more image-based embeddings from the contrastive language-image pre-training based feature extraction model; (b) applying, by the one or more hardware processors, the one or more image-based embeddings into the ML-based classifier that is trained to differentiate the one or more users from the one or more presentation attacks; (c) analyzing, by the one or more hardware processors, the one or more image-based embeddings for liveness indicators comprising at least one of: skin texture patterns compliance with live human skin, natural facial micro-movements and expressions, light reflection patterns on face and eyes, and depth and dimensionality cues, using the trained ML-based classifier; and (d) classifying the analyzed one or more image-based embeddings against one or more known attack vectors comprising at least one of: printed photographs of people, photos displayed on the one or more edge devices, physical masks, and three dimensional profiles, to determine whether the one or more users are the one or more live users, using the trained ML-based classifier.

In yet another embodiment, determining whether the obtained one or more videos are authentic based on the deepfake detection, using the ML-based classifier, comprises: (a) receiving, by the one or more hardware processors, the one or more image-based embeddings and the one or more audio-based embeddings, from the contrastive language-image pre-training based feature extraction model and the deep representation learning based feature extraction model; (b) applying, by the one or more hardware processors, the one or more image-based embeddings and the one or more audio-based embeddings, into the ML-based classifier that is trained to differentiate the one or more users from the one or more presentation attacks and to authenticate the one or more videos; (c) analyzing, by the one or more hardware processors, at least one of: the one or more image-based embeddings for liveness indicators comprising at least one of: skin texture patterns compliance with live human skin, natural facial micro-movements and expressions, light reflection patterns on face and eyes, and depth and dimensionality cues, using the trained ML-based classifier, and the one or more audio-based embeddings for authenticity indicators comprising at least one of: natural speech patterns and intonations, voice consistency throughout the one or more passphrases, and absence of synthetic audio artifacts, using the trained ML-based classifier; and (d) determining, by the one or more hardware processors, an authenticity of the obtained one or more videos based on the analyzed one or more image-based embeddings and one or more audio-based embeddings.

In yet another embodiment, the ML-based method further comprising: (a) triggering, by the one or more hardware processors, image-based liveness detection immediately upon generation of the one or more image-based embeddings; (b) triggering, by the one or more hardware processors, audio-based deepfake detection immediately upon generation of the one or more audio-based embeddings; (c) executing, by the one or more hardware processors, the image-based liveness detection and the audio-based deepfake detection, asynchronously in an execution pipeline; and (d) eliminating, by the one or more hardware processors, sequential processing delays to maintain real-time latency thresholds.

In yet another embodiment, the ML-based method further comprising streaming, by the one or more hardware processors, one or more biometric data packets comprising one or more audio frames and one or more image frames to an on-device inference engine in real-time. The on-device inference engine is configured to perform incremental embedding updates and continuous liveness scoring to provide a preliminary validation state before the one or more users have completed speaking the one or more passphrases.

In yet another embodiment, the ML-based method further comprising: (a) initializing, by the one or more hardware processors, one or more ML-based classifiers in device memory upon initiation of capturing of the one or more videos; (b) passing, by the one or more hardware processors, the one or more first embeddings between the one or more ML-based classifiers using a shared-memory architecture; and (c) eliminating, by the one or more hardware processors, data copying overhead and mitigating processing latency.

In yet another embodiment, the ML-based method further comprising: (a) detecting, by the one or more hardware processors, an initiation of the one or more high-risk transactions by one or more previously validated users on the one or more edge devices; (b) obtaining, by the one or more hardware processors, one or more re-authentication inputs associated with the one or more users through the one or more image capturing units of the one or more edge devices; (c) generating, by the one or more hardware processors, one or more re-authentication embeddings from the one or more re-authentication inputs using the one or more feature extraction models executing on the one or more edge devices; (d) comparing, by the one or more hardware processors, the generated one or more re-authentication embeddings against the one or more first embeddings retrieved from the secured local storage of the one or more edge devices, wherein comparing is performed entirely on the one or more edge devices without transmitting at least one of: biometric data and embeddings to an external server; and (e) validating, by the one or more hardware processors, the one or more users to perform a transaction associated with the one or more high-risk transactions when the one or more re-authentication embeddings match the one or more first embeddings within a configurable similarity threshold.

In yet another embodiment, the one or more first inputs comprise the one or more videos of the one or more users speaking the one or more passphrases, captured through the one or more image capturing units of the one or more edge devices. The one or more first embeddings comprise the one or more image-based embeddings generated from the one or more still frames extracted from the one or more videos, and one or more audio-based embeddings generated from the one or more audio segments extracted from the one or more passphrases spoken by the one or more users during the one or more videos.

In yet another embodiment, performing at least one of: the liveness detection and the deepfake detection, further comprises: (a) initializing, by the one or more hardware processors, the one or more ML-based classifiers in device memory of the one or more edge devices upon initiation of obtaining the one or more first inputs; (b) triggering, by the one or more hardware processors, the liveness detection immediately upon generation of the one or more image-based embeddings from the one or more first inputs; (c) triggering, by the one or more hardware processors, the deepfake detection immediately upon generation of the one or more audio-based embeddings from the one or more first inputs; (d) executing, by the one or more hardware processors, the liveness detection and the deepfake detection concurrently and asynchronously in an execution pipeline; and (e) passing, by the one or more hardware processors, the one or more first embeddings between the one or more ML-based classifiers using the shared-memory architecture, wherein the one or more ML-based classifiers access the one or more first embeddings from a common memory location without copying the one or more first embeddings to separate memory locations, for eliminating data copying overhead and reducing processing latency.

In yet another embodiment, the ML-based method further comprising: (a) streaming, by the one or more hardware processors, the one or more biometric data packets comprising the one or more audio frames and the one or more image frames to the on-device inference engine in real-time as the one or more first inputs are being obtained; (b) performing, by the one or more hardware processors, the incremental embedding updates by progressively refining the one or more first embeddings as each of the one or more audio frames and one or more image frames is received by the on-device inference engine; and (c) generating, by the one or more hardware processors, the preliminary validation state based on the continuous liveness scoring updated with each received frame, wherein the preliminary validation state is produced before the one or more users have completed providing the one or more first inputs.

In one aspect, a machine learning (ML)-based system for optimized real-time identity verification of one or more users on one or more edge devices, is disclosed. The ML-based system includes one or more hardware processors and a memory coupled to the one or more hardware processors. The memory includes a plurality of subsystems in the form of programmable instructions executable by the one or more hardware processors.

The plurality of subsystems comprises an input obtaining subsystem configured to obtain one or more first inputs associated with the one or more users from one or more image capturing units of the one or more edge devices, using a software development kit configuring on the one or more edge devices

The plurality of subsystems further comprises an embeddings generating subsystem configured to generate one or more first embeddings from the one or more first inputs associated with the one or more users, using one or more feature extraction models executing on the one or more edge devices. In an embodiment, raw biometric data from which the one or more first embeddings are generated is processed entirely on the one or more edge devices and is not transmitted externally from the one or more edge devices.

The plurality of subsystems further comprises a liveness determining subsystem configured to perform at least one of: liveness detection and deepfake detection, on the one or more edge devices based on the generated one or more first embeddings, using a ML-based classifier executing on the one or more edge devices.

The plurality of subsystems further comprises an embeddings storing subsystem configured to store the generated one or more first embeddings in a secured local storage of the one or more edge devices.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning (ML)-based system for optimized real-time identity verification of one or more users on one or more edge devices, in accordance with an embodiment of the present disclosure;

FIG. 2 is a detailed view of the ML-based system for optimized real-time identity verification of the one or more users on the one or more edge devices, in accordance with another embodiment of the present disclosure;

FIG. 3 is an overview of a concurrent processing pipeline in low-latency biometric verification of the one or more users, in accordance with another embodiment of the present disclosure;

FIG. 4A-4B is a process flow depicting optimized real-time identity verification of the one or more users on the one or more edge devices, in accordance with another embodiment of the present disclosure; and

FIG. 5 is a flow chart illustrating a ML-based method for optimized real-time identity verification of the one or more users on the one or more edge devices, in accordance with another embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

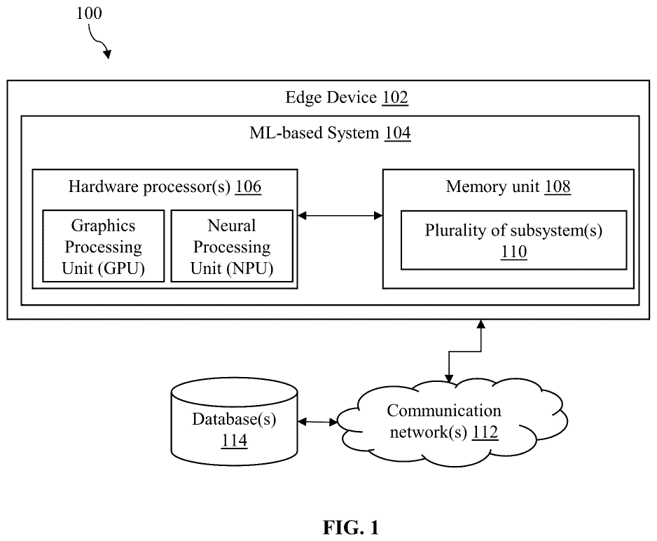

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a block diagram illustrating a computing environment 100 with a ML-based system 104 for optimized real-time identity verification of one or more users on one or more edge devices 102, in accordance with an embodiment of the present disclosure. According to FIG. 1, the computing environment 100 includes the one or more edge devices 102 that are communicatively coupled to the ML-based system 104. In an embodiment, the ML-based system 104 may be configured within the one or more edge devices 102 and one or more servers (i.e., one or more remote servers). The one or more edge devices 102 through which one or more users receive output results from the ML-based system 104.

The present invention is configured to perform optimized real-time identity verification of the one or more users on the one or more edge devices 102. The ML-based system 104 is initially configured to obtain one or more first inputs associated with the one or more users from one or more image capturing units of the one or more edge devices 102, using a software development kit configuring on the one or more edge devices 102. In an embodiment, the one or more first inputs may be encrypted and decrypted by the ML-based system 104, so that one or more third party users cannot be authenticated to manipulate the one or more first inputs.

The ML-based system 104 is further configured to generate one or more first embeddings from the one or more first inputs associated with the one or more users, using one or more feature extraction models executing on the one or more edge devices. In an embodiment, raw biometric data from which the one or more first embeddings are generated is processed entirely on the one or more edge devices 102 and is not transmitted externally from the one or more edge devices 102. The ML-based system 104 is further configured to perform at least one of: liveness detection and deepfake detection, on the one or more edge devices 102 based on the generated one or more first embeddings, using a ML-based classifier executing on the one or more edge devices 102.

The ML-based system 104 is further configured to store the generated one or more first embeddings in a secured local storage of the one or more edge devices 102.

The ML-based system 104 may be hosted/connected on/to a central server including at least one of: a cloud server or a remote server, through a communication network 112. Further, the communication network 112 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more edge devices 102 may include at least one of: a laptop computer, a desktop computer, a tablet computer, a Smartphone, a wearable device, a Smart watch, and the like.

The ML-based system 104 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or one or more hardware processors 106. The ML-based system 104 comprises the one or more hardware processors 106 and a memory unit 108. The memory unit 108 is operatively connected to the one or more hardware processors 106. The memory unit 108 comprises a set of computer-readable instructions in the form of a plurality of subsystems 110, configured to be executed by the one or more hardware processors 106.

In an exemplary embodiment, the one or more hardware processors 106 may include, for example, microprocessors, microcomputers, microcontrollers, digital signal processors, central processing units, state machines, logic circuits, and/or any devices that manipulate data or signals based on operational instructions. Among other capabilities, the one or more hardware processors 106 may fetch and execute computer-readable instructions in the memory unit 108 operationally coupled with the ML-based system 104 for performing tasks such as data processing, input/output processing, and/or any other functions. Any reference to a task in the present disclosure may refer to an operation being or that may be performed on data. The one or more hardware processors 106 are high-performance processors capable of handling large volumes of data and complex computations. The one or more hardware processors 106 may be, but not limited to, at least one of: multi-core central processing units (CPU), graphics processing units (GPUs), and the like that enhance an ability of the ML-based system 104 to process real-time data from one or more sources simultaneously.

In an embodiment, the one or more hardware processors 106 may further include at least one of: a graphics processing unit (GPU) and a neural processing unit (NPU). The graphics processing unit is a specialized processor originally designed to render graphics, and widely used for parallel computation, especially in AI and machine learning. The neural processing unit is a processor specifically designed to accelerate neural network operations and AI and ML inference tasks.

Further, the computing environment 100 includes one or more databases 114 communicatively coupled to the ML-based system 104 through the communication network 112. In an embodiment, the one or more databases 114 may store one or more embeddings associated with at least one of: the one or more selfies, the one or more videos of the one or more users speaking one or more passphrases. In an embodiment, the one or more databases 114 may include at least one of: one or more relational databases, one or more object-oriented databases, one or more data warehouses, one or more cloud-based databases, and the like. In another embodiment, a format of the one or more embeddings may include at least one of: a comma-separated values (CSV) format, a JavaScript Object Notation (JSON) format, an Extensible Markup Language (XML), spreadsheets, and the like.

In an exemplary embodiment, the ML-based system 104 may be implemented by way of a single device or a combination of multiple devices that may be operatively connected or networked together. The ML-based system 104 may be implemented in hardware or a suitable combination of hardware and software.

Though few components and the plurality of subsystems 110 are disclosed in FIG. 1, there may be additional components and subsystems which is not shown, such as, but not limited to, ports, routers, repeaters, firewall devices, network devices, the one or more databases 114, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the ML-based system 104, and the one or more edge devices 102 connected to the one or more databases 114, one skilled in the art can envision that the ML-based system 104, and the one or more edge devices 102 may be connected to several user devices located at various locations and several databases via the one or more communication networks 112.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the ML-based system 104 as is unique to the present disclosure or necessary for an understanding of the present disclosure is depicted and described. The remainder of the construction and operation of the ML-based system 104 may conform to any of the various current implementations and practices that were known in the art.

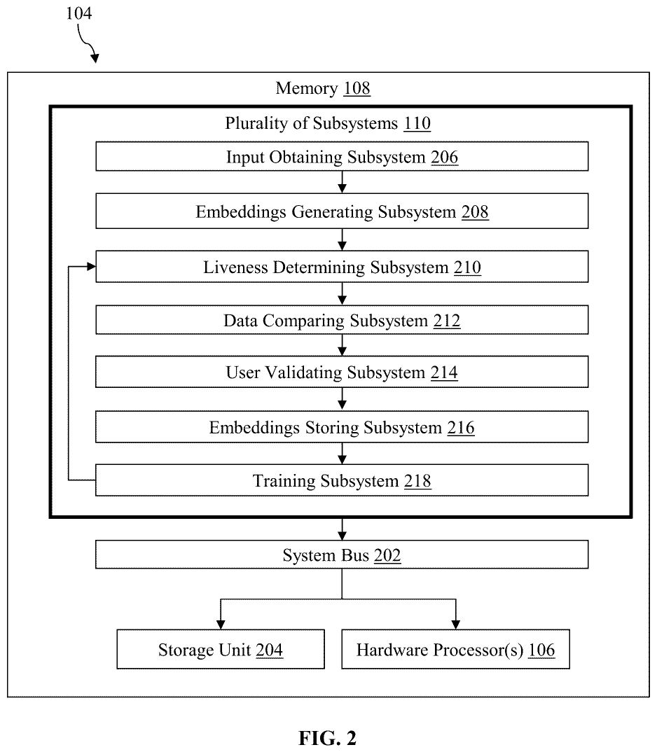

FIG. 2 is a detailed view of the ML-based system 104 for optimized real-time identity verification of the one or more users on the one or more edge devices 102, in accordance with another embodiment of the present disclosure.

In an exemplary embodiment, the ML-based system 104 comprises the one or more hardware processors 106, the memory unit 108, and a storage unit 204. The one or more hardware processors 106, the memory unit 108, and the storage unit 204 are communicatively coupled through a system bus 202 or any similar mechanism. The system bus 202 functions as the central conduit for data transfer and communication between the one or more hardware processors 106, the memory unit 108 (i.e., a memory), and the storage unit 204. The system bus 202 facilitates the efficient exchange of information and instructions, enabling the coordinated operation of the ML-based system 104. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 108 is operatively connected to the one or more hardware processors 106. The memory unit 108 comprises the plurality of subsystems 110 in the form of programmable instructions executable by the one or more hardware processors 106. The plurality of subsystems 110 comprises an input obtaining subsystem 206, an embeddings generating subsystem 208, a liveness determining subsystem 210, a data comparing subsystem 212, a user validating subsystem 214, an embeddings storing subsystem 216, and a training subsystem 218.

The one or more hardware processors 106 means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 106 may also include embedded controllers, such as generic or programmable logic devices or arrays, application-specific integrated circuits, single-chip computers, and the like.

The memory unit 108 may be the non-transitory volatile memory and the non-volatile memory. The memory unit 108 may be coupled to communicate with the one or more hardware processors 106, such as being a computer-readable storage medium. The one or more hardware processors 106 may execute machine-readable instructions and/or source code stored in the memory unit 108. A variety of machine-readable instructions may be stored in and accessed from the memory unit 108. The memory unit 108 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 108 includes the plurality of subsystems 110 stored in the form of machine-readable instructions on any of the above-mentioned storage media and may be in communication with and executed by the one or more hardware processors 106.

The storage unit 204 may be a cloud storage or the one or more databases 114 such as those shown in FIG. 1. The storage unit 204 may store, but not limited to, recommended course of action sequences dynamically generated by the ML-based system 104. The action sequences comprise obtaining inputs, embeddings generation, live users determination, embeddings matching, users validation, embeddings storing, and the like. Additionally, the storage unit 204 may retain previous action sequences for comparison and future reference, enabling continuous refinement of the ML-based system 104 over time. The storage unit 204 may be any kind of database such as, but not limited to, relational databases, dedicated databases, dynamic databases, monetized databases, scalable databases, cloud databases, distributed databases, any other databases, and a combination thereof.

The plurality of subsystems 110 includes the input obtaining subsystem 206 that is communicatively connected to the one or more hardware processors 106. The input obtaining subsystem 206 is configured to obtain the one or more first inputs associated with the one or more users through the one or more image capturing units of the one or more edge devices 102, using the software development kit configuring on the one or more edge devices 102. The one or more first inputs may include at least one of: one or more selfies and the one or more videos of the one or more users speaking the one or more passphrases, captured through the one or more image capturing units of the one or more edge devices 102.

The one or more first inputs are the initial biometric data captured from the one or more user. The image capturing units may be the camera and microphone components of the one or more edge devices 102. The one or more edge devices 102 are local user devices such as smartphones, tablets, or browsers. The software development kit (SDK) is an embedded software package that enables the KYC functionality within a hosting application. The one or more passphrases are specific phrases the one or more users are required to speak (e.g., “I love Singapore and SingPass”). Obtaining of the one or more first inputs initiates the identity verification process by capturing the one or more selfies and the one or more videos of the one or more users speaking a designated passphrase through the device's camera and microphone, with all capture operations controlled by the SDK running locally on the edge device 102. For example, a user opens the SingPass app on their iPhone, the Yella SDK triggers the front camera and microphone, and the user records a short video saying “I love Singapore and SingPass” and this captured video constitutes the first input for subsequent embedding generation and verification.

The plurality of subsystems 110 includes the embeddings generating subsystem 208 that is communicatively connected to the one or more hardware processors 106. The embeddings generating subsystem 208 is configured to generate the one or more first embeddings from the one or more first inputs associated with the one or more users, using the one or more feature extraction models executing on the one or more edge devices 102. The one or more first embeddings may include the one or more image-based embeddings generated from one or more still frames extracted from the one or more videos, and one or more audio-based embeddings generated from one or more audio segments extracted from the one or more passphrases spoken by the one or more users during the one or more videos. The embeddings generating subsystem 208 is a software module within the SDK that converts raw biometric data into compact numerical representations called embeddings. In an embodiment, the raw biometric data from which the one or more first embeddings are generated is processed entirely on the one or more edge devices 102 and is not transmitted externally from the one or more edge devices 102. The one or more first embeddings comprise the one or more image-based embeddings (512-element floating point vectors extracted from video still frames using a contrastive language-image pre-training (CLIP) based feature extraction model that captures facial structure, geometry, and unique identifying patterns) and one or more audio-based embeddings (192-element floating point vectors extracted from the spoken passphrase using a deep representation learning based feature extraction model (e.g., Titanet) that capture voice patterns, speech rhythm, and vocal signatures). The feature extraction models are neural network-based models such as CLIP for analyzing visual features and deep representation learning based feature extraction model for analyzing audio characteristics. The feature extraction models process raw data through hierarchical feature extraction and map the results into a shared embedding space. The step generating the one or more first embeddings transforms the captured video into machine-comparable numerical vectors by extracting still frames and audio segments, then processing them through the specialized feature extraction models to generate unique signatures. For example, the SDK extracts still frames from the user's selfie video and the audio of them speaking the passphrase, then CLIP converts each frame into a 512-element vector while the deep representation learning based feature extraction model converts the audio into a 192-element vector, together forming the one or more first embeddings used for subsequent verification.

For generating the one or more first embeddings comprising the one or more image-based embeddings using the one or more feature extraction models, the embeddings generating subsystem 208 is further configured to: (a) extract one or more still frames from the one or more videos of the one or more users; (b) process the extracted one or more still frames to analyze one or more visual features of the one or more still frames comprising facial structure, facial features and facial patterns, using the contrastive language-image pre-training based feature extraction model by: receiving the one or more still frames extracted from the one or more videos of the one or more users, pre-processing the one or more still frames by resizing and normalizing one or more pixel values of the one or more still frames to a standard format, applying the pre-processed one or more still frames to extract one or more hierarchical visual features through a neural network encoder, wherein the one or more hierarchical visual features comprise at least one of: low-level visual features comprising edges, textures, and color gradients, mid-level visual features comprising facial contours, eye shapes, and nose structure, and high-level visual features comprising overall facial geometry, and unique identifying patterns, and mapping the extracted one or more hierarchical visual features into a shared embedding space where similar still frames are positioned in relative proximity; and (c) output a pre-determined size of element floating point vector indicating a unique signature of the one or more still frames.

The embeddings generating subsystem 208 is a software module within the SDK responsible for converting raw image data into compact numerical representations. The one or more first embeddings are the initial vector representations generated from the user's captured video. The one or more image-based embeddings are numerical vectors derived from visual data that capture the user's facial characteristics. The one or more still frames are individual image snapshots extracted from the one or more captured videos. The one or more visual features are the observable characteristics of the image including facial structure (overall shape and arrangement of the face), facial features (specific elements like eyes, nose, mouth), and facial patterns (unique textures and identifying marks). The contrastive language-image pre-training (CLIP) based feature extraction model is a neural network trained to understand and encode visual content into meaningful vector representations.

Pre-processing the one or more still frames involves preparing the images by resizing (adjusting dimensions to a uniform size) and normalizing pixel values (scaling color values to a standard range). The neural network encoder is a deep learning architecture (such as a Vision Transformer or ResNet) that processes images through multiple sequential layers to progressively extract and refine visual information. The one or more hierarchical visual features are multi-level representations extracted at different depths of the neural network, where each layer captures increasingly complex and abstract patterns. At the initial layers, the neural network encoder extracts low-level visual features comprising basic elements such as edges (boundaries between regions), textures (surface patterns and roughness), and color gradients (transitions between colors), these are fundamental building blocks present in any image. At the intermediate layers, the neural network encoder extracts mid-level visual features comprising more structured elements such as facial contours (outline of the face), eye shapes (geometry and structure of eyes), and nose structure (shape and proportions of the nose), these represent combinations of low-level features forming recognizable facial components. At the deeper layers, the neural network encoder extracts high-level visual features comprising complex abstract patterns such as overall facial geometry (spatial arrangement and proportions of all facial elements), and unique identifying patterns (distinctive characteristics that differentiate one person from another), these represent the holistic understanding of the face as a complete identity. The extraction process is hierarchical because each subsequent layer builds upon the features extracted by previous layers, creating increasingly sophisticated representations. This step applies the pre-processed still frames to the neural network encoder, which sequentially processes the image through its layers, extracting low-level features first, combining them into mid-level features, and finally synthesizing high-level features that capture the unique identity of the user's face.

The shared embedding space is a multi-dimensional vector space where visually similar images are positioned closer together. The pre-determined size of element floating point vector is a fixed-length numerical array (512 elements) representing the image's unique signature. Overall, the one or more image-based embeddings generation step extracts still frames from the video, preprocesses them to a standard format, passes them through the CLIP neural network encoder to extract hierarchical features at multiple levels, and maps these features into a shared embedding space to output a compact vector. For example, the SDK extracts a still frame of the user's face, resizes it to 224×224 pixels and normalizes pixel values to 0-1 range, the CLIP encoder then extracts edges and textures (low-level), eye shapes and nose contours (mid-level), and overall facial geometry (high-level), finally mapping these into a 512-element floating point vector where similar faces would have vectors positioned closely together in the embedding space.

For generating the one or more first embeddings comprising the one or more audio-based embeddings using the one or more feature extraction models, the embeddings generating subsystem 208 is further configured to: (a) extract one or more audio segments from the one or more passphrases spoken by one or more users during the one or more videos; (b) process the extracted one or more audio segments to analyze one or more audio characteristics of the one or more audio segments comprising voice patterns, speech features, and vocal signatures, using a deep representation learning based feature extraction model by: receiving the one or more audio segments extracted from the one or more passphrases spoken by one or more users during the one or more videos, pre-processing the one or more audio segments by converting raw audio waveform into spectral data comprising at least one of: mel-frequency cepstral coefficients or spectrograms, applying the spectral data to extract one or more hierarchical audio features through a neural network encoder, wherein the one or more hierarchical audio features comprise at least one of: low-level audio features comprising pitch, tone, and frequency patterns, mid-level audio features comprising phoneme characteristics, speech rhythm, and cadence, and high-level audio features comprising speaker-specific vocal signatures, and unique voice patterns, and mapping the extracted one or more hierarchical audio features into a shared embedding space where similar voices are positioned in relative proximity; and (c) output a pre-determined size of element floating point vector indicating a unique signature of the one or more audio segments.

The one or more audio-based embeddings are numerical vectors derived from audio data that capture the user's voice characteristics. The one or more audio segments are portions of audio extracted from the one or more videos containing the user's spoken passphrase. The audio characteristics are the observable properties of the audio including voice patterns (unique qualities of how a person's voice sounds), speech features (characteristics of how words are spoken), and vocal signatures (distinctive voice traits that identify an individual). The deep representation learning based feature extraction model is a specialized neural network trained to understand and encode audio content into meaningful vector representations optimized for speaker verification.

Pre-processing the one or more audio segments involves preparing the audio by converting raw audio waveform (the original analog-to-digital signal) into spectral data comprising mel-frequency cepstral coefficients (MFCCs) (coefficients representing the short-term power spectrum of sound on a mel scale that mimics human hearing) or spectrograms (visual representations of the spectrum of frequencies over time). The neural network encoder for audio is a deep learning architecture (such as a convolutional or transformer-based network) that processes spectral data through multiple sequential layers to progressively extract and refine audio information. The one or more hierarchical audio features are multi-level representations extracted at different depths of the neural network. At the initial layers, the neural network encoder extracts low-level audio features comprising basic elements such as pitch (fundamental frequency of the voice), tone (quality and timbre of sound), and frequency patterns (distribution of sound energy across frequencies), and these are fundamental acoustic properties. At the intermediate layers, the neural network encoder extracts mid-level audio features comprising more structured elements such as phoneme characteristics (properties of individual speech sounds), speech rhythm (timing and pace of speech), and cadence (rise and fall patterns in speech), and these represent combinations of low-level features forming recognizable speech components. At the deeper layers, the neural network encoder extracts high-level audio features comprising complex abstract patterns such as speaker-specific vocal signatures (unique voice qualities identifying an individual) and unique voice patterns (distinctive speech characteristics), and these represent the holistic understanding of the voice as a complete identity.

The shared embedding space is a multi-dimensional vector space where acoustically similar voices are positioned closer together. The pre-determined size of element floating point vector is a fixed-length numerical array (192 elements) representing the audio's unique signature. Overall, the one or more image-based embeddings generation step extracts audio segments from the video, converts the raw waveform into spectral representations, passes them through the deep representation learning based feature extraction model's neural network encoder to extract hierarchical features at multiple levels, and maps these features into a shared embedding space to output a compact vector. For example, the SDK extracts the audio of the user saying “I love Singapore and SingPass,” converts the waveform into MFCCs capturing frequency characteristics, the deep representation learning based feature extraction model's encoder then extracts pitch and tone (low-level), phoneme sounds and speech rhythm (mid-level), and the user's unique vocal signature (high-level), finally mapping these into a 192-element floating point vector where similar voices would have vectors positioned closely together in the embedding space.

The plurality of subsystems 110 further includes the liveness determining subsystem 210 that is communicatively connected to the one or more hardware processors 106. The liveness determining subsystem 210 is configured to perform at least one of: the liveness detection and the deepfake detection, on the one or more edge devices 102 based on the generated one or more first embeddings, using the ML-based classifier executing on the one or more edge devices 102.

The liveness determining subsystem 210 is a software module within the SDK responsible for verifying that the user is a real, live person and that the captured video is authentic. The liveness detection is the process of determining whether the user is physically present and not a presentation attack using printed photos, mobile screens, masks, or 3D profiles. The deepfake detection is the process of determining whether the video and audio are genuine human-generated content and not AI-synthesized or cloned media. The ML-based classifier is a machine learning model trained offline on datasets of real users versus presentation attacks (for liveness) and authentic content versus AI-generated content (for deepfake), which applies learned patterns to classify new inputs. Overall, this step receives the generated embeddings, inputs them into the trained ML classifiers, analyzes them for liveness indicators (skin texture, micro-movements, light reflections, depth cues) and authenticity indicators (natural speech patterns, absence of synthetic artifacts), and outputs determinations for both checks simultaneously.

For example, when the user's embeddings are generated, the liveness classifier analyzes the image embeddings to confirm the face shows natural skin texture and micro-expressions (not a printed photo or mask), while concurrently the deepfake classifier analyzes both image and audio embeddings to confirm the video shows no AI-generated artifacts and the voice exhibits natural speech patterns, i.e., both determinations are completed in parallel to minimize latency.

For determining whether the one or more users are the one or more live users based on the generated one or more first embeddings, using the ML-based classifier with the liveness detection, the liveness determining subsystem 210 is configured to: (a) receive the one or more image-based embeddings from the contrastive language-image pre-training based feature extraction model; (b) apply the one or more image-based embeddings into the ML-based classifier that is trained to differentiate the one or more users from the one or more presentation attacks; (c) analyze the one or more image-based embeddings for liveness indicators comprising at least one of: skin texture patterns compliance with live human skin, natural facial micro-movements and expressions, light reflection patterns on face and eyes, and depth and dimensionality cues, using the trained ML-based classifier; and (d) classify the analyzed one or more image-based embeddings against one or more known attack vectors comprising at least one of: printed photographs of people, photos displayed on the one or more edge devices 102, physical masks, and three dimensional profiles, to determine whether the one or more users are the one or more live users, using the trained ML-based classifier.

The ML-based classifier is a machine learning model trained to distinguish live users from presentation attacks by analyzing the one or more image-based embeddings. The one or more image-based embeddings are 512-element floating point vectors generated from the user's selfie using the contrastive language-image pre-training (CLIP) based feature extraction model. The liveness indicators are characteristics that signify a real, live person including skin texture patterns compliance with live human skin (natural pores, wrinkles, and skin surface details), natural facial micro-movements and expressions (subtle involuntary movements like blinking and muscle twitches), light reflection patterns on face and eyes (natural specular reflections indicating 3D surface), and depth and dimensionality cues (spatial depth information distinguishing flat images from real faces). The presentation attacks are fraudulent attempts to spoof the system using known attack vectors comprising printed photographs of people (paper printouts of faces), photos displayed on edge devices 102 (images shown on mobile screens or monitors), physical masks (3D face coverings), and three dimensional profiles (sculpted or moulded face replicas).

The ML-based classifiers used for liveness detection are: (1) Convolutional Neural Network (CNN) classifier, i.e., a deep learning model that processes image embeddings through convolutional layers to detect spatial patterns associated with live faces versus spoofs, excelling at identifying texture inconsistencies and unnatural edges in presentation attacks; and (2) Support Vector Machine (SVM) classifier, i.e., a traditional machine learning model that creates a hyperplane in the embedding space to separate live user embeddings from attack embeddings, effective for binary classification with high-dimensional vectors.

Overall, the determination of the liveness step receives the image-based embeddings, applies them to the trained classifier which analyzes liveness indicators, and classifies the input against known attack vectors to output a determination. For example, the classifier receives the user's 512-element embedding, analyzes it for natural skin texture and light reflections, compares these patterns against learned characteristics of printed photos and masks, and determines the user is live because the embedding exhibits natural micro-movement patterns and proper depth cues absent in presentation attacks.

The plurality of subsystems 110 further includes the training subsystem 218 that is communicatively connected to the one or more hardware processors 106. The training subsystem 218 may be configured to train the ML-based classifier, by: (a) collecting one or more first training datasets of real live user images and presentation attack images comprising at least one of: printed photos, mobile screens, the physical masks, and the three dimensional profiles; (b) extracting the one or more image-based embeddings from the one or more first training datasets using the contrastive language-image pre-training based feature extraction model; (c) training the ML-based classifier to learn one or more patterns that differentiate the one or more live users from the one or more presentation attacks; and (d) optimizing the ML-based classifier to mitigate false positives and false negatives.

The training is the offline process of teaching the ML-based classifier to recognize patterns that distinguish live users from presentation attacks. The one or more first training datasets are curated collections of labelled images used to train the ML-based classifier, comprising real live user images (authentic photographs of actual people captured in real-time) and presentation attack images including printed photos (paper printouts of faces), mobile screens (faces displayed on smartphones or tablets), physical masks (3D face coverings made of silicone, paper, or other materials), and three dimensional profiles (sculpted or moulded face replicas). The one or more patterns are the distinguishing characteristics learned by the ML-based classifier that differentiate live users (natural skin texture, micro-movements, depth cues) from the one or more presentation attacks (flat surfaces, unnatural edges, missing reflections).

The false positives occur when the ML-based classifier incorrectly identifies a presentation attack as a live user, while false negatives occur when the ML-based classifier incorrectly rejects a real live user as an attack. The optimizing involves adjusting classifier parameters, thresholds, and weights to minimize both error types and achieve balanced accuracy.

Overall, the training step of the ML-based classifier collects diverse training data representing real users and various attack types, extracts embeddings from all images using CLIP, feeds these labelled embeddings to the classifier which learns discriminative patterns through iterative training, and fine-tunes the model to reduce classification errors. For example, the training process collects 10,000 real user images and 10,000 attack images (2,500 each of printed photos, mobile screens, masks, and 3D profiles), extracts embeddings from all images, trains the ML-based classifier to recognize that live user embeddings exhibit natural texture patterns while attack embeddings show flat surface characteristics, and optimizes the decision threshold to achieve 99.5% accuracy with minimal false positives and false negatives.

For determining whether the obtained one or more videos are authentic based on the deepfake detection, using the ML-based classifier, the liveness determining subsystem 210 is configured to: (a) receive the one or more image-based embeddings and the one or more audio-based embeddings, from the contrastive language-image pre-training based feature extraction model and the deep representation learning based feature extraction model; (b) apply the one or more image-based embeddings and the one or more audio-based embeddings, into the ML-based classifier that is trained to differentiate the one or more users from the one or more presentation attacks and to authenticate the one or more videos; (c) analyze at least one of: the one or more image-based embeddings for liveness indicators comprising at least one of: skin texture patterns compliance with live human skin, natural facial micro-movements and expressions, light reflection patterns on face and eyes, and depth and dimensionality cues, using the trained ML-based classifier, and the one or more audio-based embeddings for authenticity indicators comprising at least one of: natural speech patterns and intonations, voice consistency throughout the one or more passphrases, and absence of synthetic audio artifacts, using the trained ML-based classifier; and (d) determining an authenticity of the obtained one or more videos based on the analyzed one or more image-based embeddings and one or more audio-based embeddings.

The deepfake detection is the process of determining whether the captured video and audio are authentic human-generated content or AI-synthesized/cloned media. The image-based embeddings are 512-element floating point vectors generated from video still frames using the contrastive language-image pre-training (CLIP) model based feature extraction model. The audio-based embeddings are 192-element floating point vectors generated from the spoken passphrase using the deep representation learning based feature extraction model. The ML-based classifier is a machine learning model trained to differentiate authentic content from AI-generated content by analyzing both image and audio embeddings. The presentation attacks include deepfake videos, face-swapped images, and voice cloning attempts. The liveness indicators for images comprise skin texture patterns compliance with live human skin (natural pores and surface details versus synthetic smoothness), natural facial micro-movements and expressions (involuntary muscle movements versus static or algorithmically generated movements), light reflection patterns on face and eyes (realistic specular highlights versus inconsistent or missing reflections), and depth and dimensionality cues (natural 3D facial structure versus flat or warped geometry).

The authenticity indicators for audio comprise natural speech patterns and intonations (organic variations in pitch and emphasis versus monotonic or irregular AI-generated speech), voice consistency throughout the passphrases (stable vocal characteristics versus fluctuating or spliced audio), and absence of synthetic audio artifacts (clean natural audio versus digital glitches, unnatural transitions, or robotic undertones typical of AI voice synthesis). The ML-based classifiers used for deepfake detection are: (1) Multimodal Fusion Neural Network classifier, i.e., a deep learning model that simultaneously processes both image and audio embeddings through parallel branches, fuses them in a joint layer, and learns cross-modal correlations to detect inconsistencies between visual and audio content (e.g., lip movements not matching speech), excelling at identifying deepfakes where video and audio are separately generated; and (2) Recurrent Neural Network (RNN) with Long Short-Term Memory (LSTM) classifier, i.e., a sequential model that analyzes temporal patterns across video frames and audio segments, detecting unnatural transitions, frame-to-frame inconsistencies, and audio discontinuities that indicate AI manipulation, effective for identifying spliced or temporally altered content.

Overall, the determination of the liveness step receives both image-based and audio-based embeddings, applies them to the trained classifier which analyzes liveness indicators in images and authenticity indicators in audio, evaluates cross-modal consistency between visual and audio content, and outputs an authenticity determination. For example, the classifier receives the user's 512-element image embedding and 192-element audio embedding, the Multimodal Fusion Network analyzes the image for natural skin texture and micro-expressions while simultaneously analyzing the audio for natural speech intonations, fuses both analyses to verify lip movements correlate with spoken words, and determines the video is authentic because both modalities exhibit natural human characteristics with consistent cross-modal alignment or flags it as a deepfake if the audio shows synthetic artifacts or the visual-audio synchronization is inconsistent.

The training subsystem 218 may further be configured to train the ML-based classifier for determining a real voice of a live user, by: (a) collecting one or more second training datasets of real human speech and an artificial intelligence generated audio; (b) extracting the one or more audio-based embeddings from the one or more second training datasets using the deep representation learning based feature extraction model; (c) training the ML-based classifier to learn one or more patterns that differentiate the real voice from a synthetic voice; and (d) optimizing the ML-based classifier to detect unnatural speech patterns.

The training is the offline process of teaching the ML-based classifier to recognize patterns that distinguish real human voices from AI-generated synthetic voices. The ML-based classifier is a machine learning model trained to differentiate authentic human speech from artificially synthesized audio. The real voice is authentic speech produced by a live human being with natural vocal characteristics. The second training datasets are curated collections of labelled audio samples used specifically for voice authenticity training, comprising real human speech (authentic voice recordings from actual people with natural vocal variations, breathing patterns, and organic speech characteristics) and artificial intelligence generated audio (synthetic voice samples created using AI technologies such as text-to-speech systems, voice cloning tools, and deepfake audio generators).

The audio-based embeddings are 192-element floating point vectors extracted from the training audio samples. The deep representation learning based feature extraction model is the specialized neural network used to convert training audio into embeddings that capture voice characteristics. The one or more patterns are the distinguishing characteristics learned by the ML-based classifier that differentiate real voices (natural pitch variations, organic breathing, authentic intonations) from synthetic voices (robotic undertones, unnatural transitions, missing micro-variations). The synthetic voice is artificially generated audio that mimics human speech but lacks natural human vocal qualities. The unnatural speech patterns are audio characteristics indicative of AI generation including monotonic delivery, irregular cadence, digital artifacts, and absence of natural speech imperfections.

Overall, this training step collects diverse audio training data representing real human speech and various AI-generated voices, extracts embeddings from all audio samples using the deep representation learning based feature extraction model, feeds these labelled embeddings to the classifier which learns discriminative patterns through iterative training, and fine-tunes the model to detect subtle unnatural speech characteristics. For example, the training process collects 50,000 real human speech samples and 50,000 AI-generated audio samples (from various synthesis tools like voice cloning and text-to-speech systems), extracts 192-element embeddings from all samples, trains the classifier to recognize that real voice embeddings exhibit natural breathing pauses and pitch micro-variations while synthetic embeddings show robotic consistency and digital artifacts, and optimizes the model to detect unnatural patterns such as missing vocal fry, absent lip smacks, and overly smooth frequency transitions typical of AI-generated audio.

The plurality of subsystems 110 further includes the data comparing subsystem 212 that is communicatively connected to the one or more hardware processors 106. During onboarding of the one or more users, the data comparing subsystem 212 is configured to: (a) extract one or more second embeddings from at least one reference image associated with one or more pre-authorized identities of the one or more users, (b) perform the cosine similarity matching between the generated one or more first embeddings by computing a cosine similarity score representing a degree of similarity between the one or more first embeddings and the one or more second embeddings, and (c) validate the one or more users when the cosine similarity score exceeds a configurable threshold value, and permit the one or more users to retry obtaining the one or more first inputs for a pre-configured maximum number of attempts when the cosine similarity score does not exceed the configurable threshold value. The data comparing subsystem 212 is a software module within the SDK responsible for matching the user's biometric data against stored identity records. The at least one image of one or more pre-authorized identities refers to the government-issued ID photo (e.g., passport, national ID card) or profile picture from a trusted source (e.g., national registry database) that serves as the reference for identity verification. The pre-authorized identities are previously verified and registered identities stored in the system or obtained from authoritative sources.

The cosine similarity matching process is a mathematical technique that measures the similarity between two embedding vectors by computing the cosine of the angle between them, and calculated by dividing the dot product of the two vectors by the product of their magnitudes, yielding a score between −1 and 1 where higher values indicate greater similarity.

The cosine similarity score is the numerical value (between −1 and 1) computed by dividing the dot product of the user's selfie embedding and the reference identity embedding by the product of their magnitudes, where higher values indicate greater similarity. The configurable threshold value is a merchant-specified similarity score (e.g., 0.85) that defines the minimum acceptable similarity for identity confirmation, and this value can be adjusted based on the security requirements of different merchants or use cases. The exceeds means the computed similarity score is greater than or equal to the threshold value, indicating a successful match between the user's live selfie and the reference identity document. Permitting the one or more users to retry means allowing the user additional attempts to capture a new selfie video if the initial comparison fails. The pre-configured maximum number of attempts is a merchant-specified limit (e.g., 3 or 5 attempts) on how many times a user can re-record their selfie video before the verification process is terminated, and this prevents unlimited retry attempts and mitigates brute-force deepfake attacks. This step compares the similarity score against the threshold, validates the user if the score exceeds the threshold, or prompts the user to retry capturing their selfie if the score falls below the threshold, up to the maximum allowed attempts. For example, if the user's selfie embedding comparison yields a score of 0.72 against a threshold of 0.85, the system rejects the match and prompts the user to retry—the user re-records their selfie, achieves a score of 0.91 on the second attempt, and is validated since 0.91 exceeds 0.85.

For performing at least one of: the liveness detection and the deepfake detection, the data comparing subsystem 212 is further configured to: (a) initialize the one or more ML-based classifiers in device memory of the one or more edge devices upon initiation of obtaining the one or more first inputs; (b) trigger the liveness detection immediately upon generation of the one or more image-based embeddings from the one or more first inputs; (c) trigger the deepfake detection immediately upon generation of the one or more audio-based embeddings from the one or more first inputs; (d) execute the liveness detection and the deepfake detection concurrently and asynchronously in an execution pipeline; and (g) pass the one or more first embeddings between the one or more ML-based classifiers using the shared-memory architecture, wherein the one or more ML-based classifiers access the one or more first embeddings from a common memory location without copying the one or more first embeddings to separate memory locations, for eliminating data copying overhead and reducing processing latency.

The initializing means loading and preparing the ML-based classifiers into an active, ready-to-execute state in device memory at the moment the video capture begins, before any biometric data is fully captured. The triggering means initiating the liveness detection and deepfake detection processes immediately as soon as their respective embeddings (image-based or audio-based) become available, without waiting for all embeddings to be generated. The concurrently and asynchronously means both detection processes execute simultaneously and independently in parallel without waiting for each other to complete. The execution pipeline is a processing architecture where multiple tasks run in parallel, with each task operating on data as it becomes available. The shared-memory architecture is a system design where multiple classifiers access the same embedding data from a common memory location rather than each classifier maintaining its own separate copy. The common memory location is a single region in device RAM where embeddings are stored once and accessed by all classifiers. The data copying overhead is the processing time and resource consumption required to duplicate data between different memory locations. The processing latency is the time delay between input and output during the verification process. This step preloads classifiers when capture starts, triggers each detection immediately upon its respective embedding generation, runs both detections in parallel, and shares embeddings through common memory to eliminate duplication delays. For example, when the user initiates KYC, the SDK loads all classifiers into RAM, at 0.5 seconds the first image embedding is generated and liveness detection immediately starts, at 0.7 seconds the first audio embedding is generated and deepfake detection starts in parallel, both classifiers read embeddings from the same memory location without copying, i.e., completing verification in 1.2 seconds instead of 2.0 seconds with sequential processing.

The plurality of subsystems 110 further includes the user validating subsystem 214 that is communicatively connected to the one or more hardware processors 106. In an aspect, the user validating subsystem 214 is configured to: (a) analyze whether the one or more users initiate the one or more high-risk transactions upon validation of the one or more users into the ML-based system 104; (b) request one or more second inputs associated with the one or more users from the one or more edge devices 102 of the one or more users, using the software development kit for re-authentication; (c) generate one or more third embeddings from the one or more second inputs associated with the one or more users, using the one or more feature extraction models; (d) compare the generated one or more third embeddings with the generated one or more first embeddings stored in the secured local storage of the one or more edge devices 102; (e) compare the generated one or more third embeddings with the generated one or more first embeddings; and (f) validate the one or more users to perform the transaction data associated with the one or more high-risk transactions when the generated one or more third embeddings are matched with the generated one or more first embeddings.

The one or more users are permitted to re-record invalid videos for a specific number of attempts that can be configured per merchant. Also, to prevent brute force deepfake trials, the edge device 102/server enforces a backoff period after a specific number of failed trials. The edge device 102/server also incorporates logic to prevent embedding based injection attacks (via nonces or server supplied signatures).

The analyze means to monitor and detect when a validated user attempts to perform sensitive operations. The one or more users are individuals who have already completed initial KYC onboarding and are now attempting subsequent transactions. The one or more high-risk transactions are sensitive operations requiring additional verification including digital token setup (configuring authentication tokens), user profile changes (modifying personal account information), account reset (recovering or resetting account credentials), and large amount transfer (high-value financial transactions). The validation of the one or more users into the ML-based system 104 refers to the user's successful completion of initial KYC onboarding.

The one or more second inputs are new biometric data (selfie and/or passphrase) captured from the one or more users at the time of the high-risk transaction for re-authentication purposes. The software development kit (SDK) is the embedded software that captures and processes the re-authentication data. The one or more third embeddings are new vector representations generated from the second inputs using the same feature extraction models (CLIP for images, the deep representation learning based feature extraction model for audio). The one or more feature extraction models are the neural networks (CLIP and the deep representation learning based feature extraction model) used to convert biometric data into embeddings. The generated one or more first embeddings are the original embeddings created during initial onboarding and stored for future verification. The secured local storage is a tamper-proof secure enclave on the edge device 102 where the first embeddings are cached. The transaction data is information about the high-risk transaction being attempted (type, amount, details). The matched means the cosine similarity score between the thirds embeddings and first embeddings exceeds the threshold, confirming the same person is performing the transaction.

Overall, the step of user validation monitors for high-risk transaction attempts, requests new biometric input from the user, generates third embeddings, compares them locally against cached first embeddings, and validates the user to proceed only if both local and comparisons confirm a match. For example, a user who completed KYC onboarding attempts a $10,000 wire transfer, the SDK detects this high-risk transaction and prompts for a new selfie, generates a 512-element third embedding from the selfie, compares it against the first embedding stored in the device's secure enclave (local match score: 0.93), compares the third embedding against its stored first embedding (server match score: 0.92), both scores exceed the 0.85 threshold, and the user is validated to complete the wire transfer.

In another aspect, the user validating subsystem 214 is further configured to: (a) detect an initiation of the one or more high-risk transactions by one or more previously validated users on the one or more edge devices 102; (b) obtain one or more re-authentication inputs associated with the one or more users through the one or more image capturing units of the one or more edge devices 102; (c) generate one or more re-authentication embeddings from the one or more re-authentication inputs using the one or more feature extraction models executing on the one or more edge devices 102; (d) compare the generated one or more re-authentication embeddings against the one or more first embeddings retrieved from the secured local storage of the one or more edge devices 102, wherein comparing is performed entirely on the one or more edge devices 102 without transmitting at least one of: biometric data and embeddings to an external server; and (e) validate the one or more users to perform a transaction associated with the one or more high-risk transactions when the one or more re-authentication embeddings match the one or more first embeddings within a configurable similarity threshold.

The detecting means monitoring and identifying when a previously validated user attempts to initiate a sensitive operation requiring additional verification. The one or more previously validated users are individuals who have already completed initial KYC onboarding and passed all identity verification checks. The one or more re-authentication inputs are new biometric data (selfie and/or passphrase) captured from the user at the time of the high-risk transaction. The one or more re-authentication embeddings are new vector representations (512-element image-based and/or 192-element audio-based) generated from the re-authentication inputs using the same feature extraction models (CLIP and Titanet). The one or more first embeddings are the original embeddings created during initial onboarding and stored in the secured local storage. The secured local storage is a tamper-proof secure enclave (e.g., iPhone Secure Enclave, Android TEE) on the edge device 102. The comparing is performed entirely on the one or more edge devices 102 means the re-authentication verification occurs locally without transmitting biometric data or embeddings to external servers, enhancing privacy and reducing latency. The configurable similarity threshold is a merchant-specified cosine similarity score (e.g., 0.85) above which a match is confirmed.

This step detects high-risk transaction attempts, captures new biometric input, generates re-authentication embeddings, compares them locally against cached first embeddings, and validates the user to proceed if the similarity threshold is met. For example, a user attempts a $10,000 wire transfer, the SDK prompts for a new selfie, generates a 512-element re-authentication embedding, compares it against the cached first embedding in the device's secure enclave yielding a score of 0.93, and validates the user to complete the transfer since 0.93 exceeds the 0.85 threshold, without server communication.

The plurality of subsystems 110 further includes the embeddings storing subsystem 216 that is communicatively connected to the one or more hardware processors 106. The embeddings storing subsystem 216 is configured to store the generated one or more first embeddings in the secured local storage of the one or more edge devices 102.

The embeddings storing subsystem 216 is a software module within the SDK responsible for securely caching biometric embeddings on the user's local device for future verification purposes. The store means to save and retain data in a persistent manner for subsequent retrieval and use. The secured local storage is a tamper-proof secure enclave on the edge device 102, i.e., a protected hardware or software-based storage area that prevents unauthorized access, modification, or extraction of sensitive biometric data. Overall, the storage step takes the validated first embeddings after successful on-device verification, encrypts them, and stores them in the device's secure enclave where they remain protected and available for rapid re-authentication during future high-risk transactions without requiring server communication. For example, after a user completes KYC onboarding and passes all validations, the embeddings storing subsystem 216 takes the 512-element image embedding and 192-element audio embedding, encrypts them using device-level security protocols, stores them in the iPhone's Secure Enclave or Android's Trusted Execution Environment (TEE), and retains them locally, enabling instant re-verification when the user later attempts a high-risk transaction like account reset, where the new selfie embedding is compared against these cached embeddings without network latency.

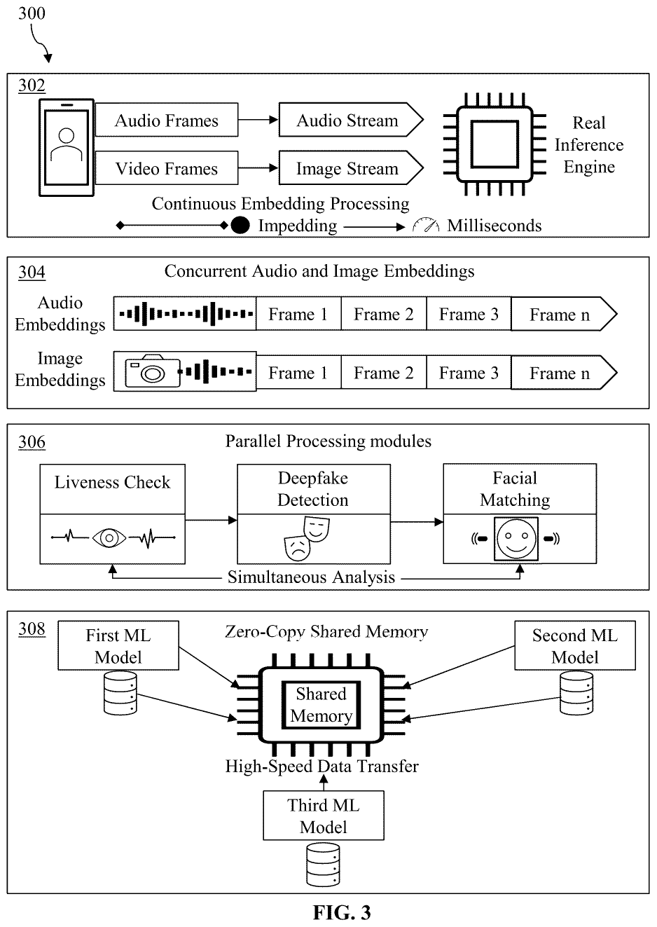

FIG. 3 is an overview of a concurrent processing pipeline 300 in low-latency biometric verification of the one or more users, in accordance with another embodiment of the present disclosure. The concurrent processing pipeline 300 illustrates the asynchronous execution pipeline where multiple processing tasks run in parallel rather than sequentially, enabling optimized real-time identity verification with minimal latency.

The following operations are performed at step 302. The SDK captures the one or more videos of the one or more users speaking the one or more passphrases. The one or more image (i.e., a selfie) and audio segments are streamed in real-time to the processing pipeline. In other words, the one or more biometric data packets comprising one or more audio frames and one or more image frames are streamed to an on-device inference engine in real-time. The on-device inference engine is configured to perform incremental embedding updates and continuous liveness scoring to provide a preliminary validation state before the one or more users completed speaking the one or more passphrases.

In other words, the SDK streams the one or more biometric data packets comprising the one or more audio frames and the one or more image frames to the on-device inference engine in real-time as the one or more first inputs are being obtained. The SDK further performs the incremental embedding updates by progressively refining the one or more first embeddings as each of the one or more audio frames and one or more image frames is received by the on-device inference engine. The SDK further generates the preliminary validation state based on the continuous liveness scoring updated with each received frame. The preliminary validation state is produced before the one or more users have completed providing the one or more first inputs.

The streaming means continuously transmitting data in small packets as it is captured rather than waiting for complete capture. The biometric data packets are small chunks of captured data comprising audio frames (short segments of the user's voice) and image frames (individual video snapshots). The on-device inference engine is a local machine learning runtime that processes embeddings and performs classification directly on the one or more edge devices 102. The real-time means processing occurs instantaneously as data arrives with minimal delay. The incremental embedding updates are progressive refinements to the embedding vectors as new frames are received, rather than generating embeddings only after complete capture. The continuous liveness scoring is ongoing assessment of whether the user is live, updated with each new frame. The preliminary validation state is an early indication of verification status before final determination. Overall, the step streams audio and image frames to the inference engine as they are captured, which progressively updates embeddings and liveness scores, providing an early validation indication before the user finishes speaking. For example, as the user begins saying “I love Singapore,” the SDK streams frames every 100 ms to the inference engine, which incrementally builds the embedding and updates the liveness score from 0.7 to 0.85 to 0.92, providing a preliminary “likely valid” state by the time the user reaches “Singapore”, before completing the full passphrase.

The following operations are performed at step 304. The one or more first embeddings comprising the one or more image-based embeddings and the one or more audio-based embeddings, are generated from the one or more first inputs associated with the one or more users. The one or more still frames are extracted and processed through the CLIP based feature extraction model to generate 512-element image-based embeddings. The one or more audio segments are extracted and processed through the deep representation learning based feature extraction model to generate 192-element audio-based embeddings. In an embodiment, both processes run concurrently as data becomes available.

The following operations are performed at step 306. The liveness detection is performed to determine whether the one or more users are one or more live users upon generation of the one or more first embeddings. The deepfake detection (image) is run in parallel analyzing the one or more image-based embeddings for determining whether the one or more videos are authentic (i.e., determining AI-generated artifacts). The deepfake detection (audio) is run in parallel analyzing audio embeddings for synthetic voice indicators. The generated one or more first embeddings of the one or more first inputs associated with the one or more users, are compared with at least one image of the one or more pre-authorized identities, using the cosine similarity matching process.

In an embodiment, the ML-based system 104 is configured to: (a) trigger image-based liveness detection immediately upon generation of the one or more image-based embeddings; (b) trigger audio-based deepfake detection immediately upon generation of the one or more audio-based embeddings; (c) execute the image-based liveness detection and the audio-based deepfake detection, asynchronously in an execution pipeline; and (d) eliminate sequential processing delays to maintain real-time latency thresholds.

The triggering means initiating or activating a process immediately upon a specific condition being met. The image-based liveness detection is the process of verifying that the user is a real, live person by analyzing image embeddings for indicators such as skin texture, micro-movements, and depth cues. The audio-based deepfake detection is the process of verifying that the spoken passphrase is authentic human speech by analyzing audio embeddings for synthetic artifacts and unnatural patterns. The one or more audio-based embeddings are the 192-element floating point vectors extracted from the audio using the deep representation learning based feature extraction model. The asynchronously means the processes execute independently and in parallel without waiting for each other to complete. The execution pipeline is a processing architecture where multiple tasks are organized to run concurrently, with each task operating on data as it becomes available. The sequential processing delays are latency overheads caused by executing tasks one after another in a linear order. The real-time latency thresholds are strict time constraints (typically milliseconds) within which the verification must complete to meet real-time performance requirements. For example, at timestamp 0.5 seconds the first image embedding is generated and liveness detection immediately begins analyzing it, at timestamp 0.7 seconds the first audio embedding is generated and deepfake detection immediately starts in parallel, both processes complete by timestamp 1.2 seconds, whereas sequential processing would have taken 2.0 seconds, the asynchronous pipeline saves 0.8 seconds to meet the 1.5-second real-time latency threshold.

At step 308, the one or more embeddings are passed between the one or more ML-based classifiers using a shared memory, for eliminating data copying overhead and minimizing processing latency. In other words, the ML-based system 104 is configured to: (a) initialize one or more ML-based classifiers in device memory upon initiation of capturing of the one or more videos; (b) pass the one or more first embeddings between the one or more ML-based classifiers using a shared-memory architecture; and (c) eliminate data copying overhead and mitigating processing latency.

The ML-based classifiers are machine learning models including the liveness classifier, image deepfake classifier, and audio deepfake classifier used for identity verification. The device memory is the RAM (Random Access Memory) of the one or more edge devices 102 where active programs and data are stored for rapid access. The one or more videos are the selfie videos of users speaking passphrases. The shared-memory architecture is a system design where multiple classifiers access the same memory region to read embeddings directly, rather than each classifier maintaining its own separate copy. The data copying overhead is the processing time and resource consumption required to duplicate data between different memory locations. The mitigating processing latency means reducing the time delay in completing the verification process.

Overall, this step preloads all ML classifiers into memory when video capture starts so they are immediately ready, then allows classifiers to access embeddings from a common memory location without duplication, thereby reducing processing time. For example, when the user initiates KYC, the SDK loads the liveness classifier, image deepfake classifier, and audio deepfake classifier into device RAM simultaneously, then as the 512-element image embedding is generated it is written once to shared memory where all three classifiers read it directly, eliminating the need to copy the embedding three times and saving approximately 50 ms of processing latency compared to traditional copy-based architectures.

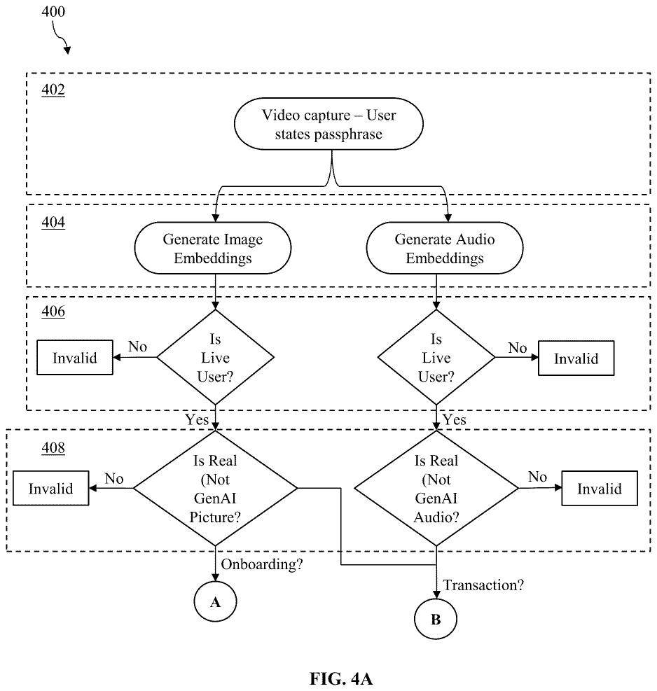

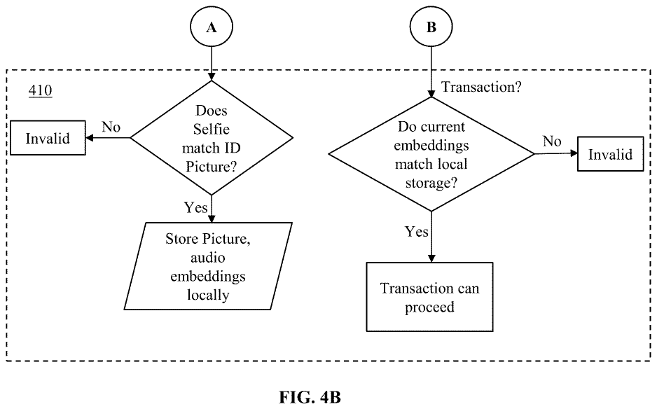

FIG. 4A-4B is a process flow 400 depicting optimized real-time identity verification of the one or more users on the one or more edge devices 102, in accordance with another embodiment of the present disclosure.

At step 402, the hosting application which embeds the SDK triggers KYC. The process begins by requesting the one or more users for a short selfie video during onboarding). The SDK captures a fixed length video of the user's face. The one or more users are requested to say a specific phrase (e.g., “I love Singapore and SingPass”). Post onboarding, the SDK gates all high risk transactions (e.g., SingPass digital token setup, user profile changes, account reset etc) with some combination of facial or audio biometrics. The KYC results are displayed to the one or more users. If the SDK is embedded in the hosting application (e.g., SingPass), the Yella SDK supplies JSON results to the hosting application.

At step 404, the one or more audio-based and the one or more image-based embeddings are extracted from the one or more videos using highly detailed feature extractors (i.e., the feature extraction models). The separate embeddings (i.e., the one or more audio-based and the one or more image-based embeddings) are generated for pictures and audio. The video is processed as a set of still frames with associated audio by segmentation. The preferred embodiment uses CLIP based feature extraction model for images. This converts images to 512 element vectors of floating point data. The deep representation learning based feature extraction model generates 192 element floating point vectors for audios.

At step 406, the user's selfie is checked to determine whether the user's selfie is real, the user is a live user, and not a presentation attack using a printed photo or a picture on a mobile device or desktop or a mask. The preferred embodiment uses the one or more first embeddings as input to the ML-based classifier. This has been trained offline specifically to classify selfies as real or not (not real could mean presentation attacks using photos of people, mobile photos, masks, 3D profiles, and the like).

At step 408, the ML-based classifier identifies real users and flags all fraudulent attempts using synthesized audio, video or pictures. The specific ML-based classifier is trained on real images and cloned images. A separate ML-based classifier has been trained on real audio and AI generated audio. These ML-based classifiers distinguish between real human generated images/audio and deepfake cloned ones.

At step 410, during onboarding, the SDK performs cosine similarity matching that compares the first embeddings of the user selfie with the second embeddings of the profile picture on the ID. A similarity score above a merchant specified threshold (configurable) indicates a match. If there is no match, the one or more users are permitted to retry recording for the pre-configured max number of attempts. If the one or more users are not onboarding, for high value transactions only, the one or more image and/or audio embeddings stored locally are compared to user supplied ones on-device. When the one or more image and/or audio embeddings match the embeddings in the local storage, then the transaction can be proceeded.

If the one or more users are setting up biometrics during an initial capture phase, these embeddings are stored in the secure local enclave on-device. This database has to be tamper-proof. The one or more image-based and audio-based embeddings may also be stored on servers. For high value transactions, account resets and other critical flows, the one or more users have to supply selfie and/or passphrase. These are converted to embeddings and compared to cached values, to proceed. The comparisons are always done by cosine matching embedding vectors. The one or more users are permitted to re-record invalid videos for the specific number of attempts that can be configured per merchant. Also, to prevent brute force deepfake trials, the edge device/server may enforce a backoff period after a specific number of failed trials. The edge device/server also incorporates logic to prevent embedding based injection attacks (via nonces or server supplied signatures).

In FIG. 4A-4B, the circular symbols with “A and B” written inside are being used as off-page connectors. These are used for indicating that FIG. 4A continues to the next page as FIG. 4B.

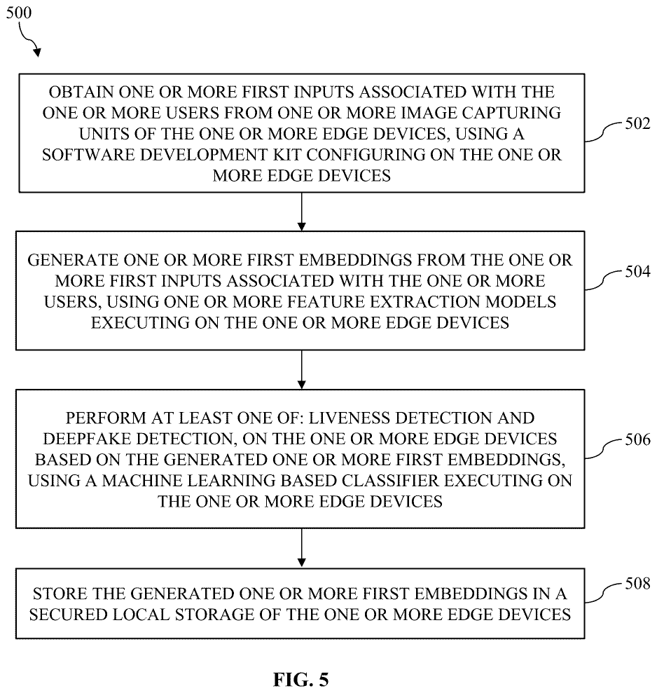

FIG. 5 is a flow chart illustrating a ML-based method 500 for optimized real-time identity verification of the one or more users on the one or more edge devices 102, in accordance with another embodiment of the present disclosure.

At step 502, the one or more first inputs associated with the one or more users are obtained/captured through the one or more image capturing units of the one or more edge devices 102, using the software development kit configuring on the one or more edge devices 102.

At step 504, the one or more first embeddings are generated from the one or more first inputs associated with the one or more users, using the one or more feature extraction models executing on the one or more edge devices 102. The raw biometric data from which the one or more first embeddings are generated is processed entirely on the one or more edge devices 102 and is not transmitted externally from the one or more edge devices 102.

At step 506, at least one of: the liveness detection and the deepfake detection, are performed on the one or more edge devices 102 based on the generated one or more first embeddings, using the ML-based classifier executing on the one or more edge devices 102.

At step 508, the generated one or more first embeddings are stored in the secured local storage of the one or more edge devices 102.

The present invention has the following advantages. The present invention with the ML-based system 104 and method 500 is configured for optimized real-time identity verification of the one or more users on the one or more edge devices 102. By initializing the ML-based classifiers in device memory upon initiation of video capture, the ML-based classifiers are preloaded and ready to execute immediately when embeddings become available, eliminating the delay of loading classifiers on-demand and enabling real-time identity verification within strict latency thresholds.

The shared-memory architecture allows multiple ML-based classifiers (liveness classifier, image deepfake classifier, audio deepfake classifier) to access the same embedding data from a common memory location, avoiding redundant storage of duplicate embeddings and optimizing device memory consumption on resource-constrained edge devices. By passing embeddings between the ML-based classifiers through shared memory rather than copying data to separate memory locations for each classifier, the ML-based system 104 eliminates computational overhead associated with data duplication, i.e., reducing CPU cycles, memory bandwidth consumption, and power usage.

The combination of preloaded ML-based classifiers and shared-memory data access enables concurrent execution of liveness detection and deepfake detection without sequential bottlenecks, meeting real-time bidding (RTB) latency thresholds required for seamless user experience during identity verification. The architecture is specifically designed for the one or more edge devices 102 (smartphones, tablets, browsers) with limited computational resources, maximizing processing efficiency while maintaining high accuracy in identity verification without relying on server-side processing.

By mitigating processing latency through preloading and shared-memory access, the one or more users experience near-instantaneous identity verification, reducing wait times (i.e., validation result in less than 300 milliseconds) during KYC onboarding and high-risk transaction authentication, improving overall user satisfaction and adoption rates. The shared-memory architecture enables multiple ML-based classifiers to operate in parallel on the same embedding data simultaneously, allowing the ML-based system 104 to scale additional verification checks without proportional increases in memory usage or processing time.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based system 104 either directly or through intervening I/O controllers. Network adapters may also be coupled to the ML-based system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based system 104 in accordance with the embodiments herein. The ML-based system 104 herein comprises at least one processor or central processing unit (CPU). The CPUs are interconnected via the system bus 202 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based system 104. The ML-based system 104 can read the inventive instructions on the program storage devices and follow these instructions to execute the methodology of the embodiments herein.

The ML-based system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine learning (ML)-based method for optimized real-time identity verification of one or more users on one or more edge devices, the ML-based method comprising:
obtaining, by one or more hardware processors, one or more first inputs associated with the one or more users through one or more image capturing units of the one or more edge devices, using a software development kit configuring on the one or more edge devices;
generating, by the one or more hardware processors, one or more first embeddings from the one or more first inputs associated with the one or more users, using one or more feature extraction models executing on the one or more edge devices, wherein raw biometric data from which the one or more first embeddings are generated is processed entirely on the one or more edge devices and is not transmitted externally from the one or more edge devices;
performing, by the one or more hardware processors, at least one of: liveness detection and deepfake detection, on the one or more edge devices based on the generated one or more first embeddings, using a ML-based classifier executing on the one or more edge devices; and
storing, by the one or more hardware processors, the generated one or more first embeddings in a secured local storage of the one or more edge devices.

2. The ML-based method of claim 1, further comprising:
extracting, by the one or more hardware processors, one or more second embeddings from at least one reference image associated with one or more pre-authorized identities of the one or more users;
performing, by the one or more hardware processors, a cosine similarity matching between the generated one or more first embeddings and the one or more second embeddings by computing a cosine similarity score representing a degree of similarity between the one or more first embeddings and the one or more second embeddings; and
validating, by the one or more hardware processors, the one or more users when the cosine similarity score exceeds a configurable threshold value, and permitting the one or more users to retry obtaining the one or more first inputs for a pre-configured maximum number of attempts when the cosine similarity score does not exceed the configurable threshold value.

3. The ML-based method of claim 1, further comprising:
analyzing, by the one or more hardware processors, whether the one or more users initiate one or more high-risk transactions upon validation of the one or more users into a ML-based system;
requesting, by the one or more hardware processors, one or more second inputs associated with the one or more users through the one or more image capturing units of the one or more edge devices, using the software development kit for re-authentication;
generating, by the one or more hardware processors, one or more third embeddings from the one or more second inputs associated with the one or more users, using the one or more feature extraction models;
comparing, by the one or more hardware processors, the generated one or more third embeddings with the generated one or more first embeddings stored in the secured local storage of the one or more edge devices;
comparing, by the one or more hardware processors, the generated one or more third embeddings with the generated one or more first embeddings; and
validating, by the one or more hardware processors, the one or more users to perform the transaction data associated with the one or more high-risk transactions when the generated one or more third embeddings are matched with the generated one or more first embeddings.

4. The ML-based method of claim 1, wherein generating the one or more first embeddings comprising one or more image-based embeddings using the one or more feature extraction models, comprises:
extracting, by the one or more hardware processors, one or more still frames from one or more videos of the one or more users;
processing, by the one or more hardware processors, the extracted one or more still frames to analyze one or more visual features of the one or more still frames comprising facial structure, facial features and facial patterns, using a contrastive language-image pre-training based feature extraction model by:
receiving, by the one or more hardware processors, the one or more still frames extracted from the one or more videos of the one or more users;
pre-processing, by the one or more hardware processors, the one or more still frames by resizing and normalizing one or more pixel values of the one or more still frames to a standard format;
applying, by the one or more hardware processors, the pre-processed one or more still frames to extract one or more hierarchical visual features through a neural network encoder, wherein the one or more hierarchical visual features comprise at least one of: low-level visual features comprising edges, textures, and color gradients, mid-level visual features comprising facial contours, eye shapes, and nose structure, and high-level visual features comprising overall facial geometry, and unique identifying patterns; and
mapping, by the one or more hardware processors, the extracted one or more hierarchical visual features into a shared embedding space where similar still frames are positioned in relative proximity; and
outputting, by the one or more hardware processors, a pre-determined size of element floating point vector indicating a unique signature of the one or more still frames.

5. The ML-based method of claim 1, wherein generating the one or more first embeddings comprising the one or more audio-based embeddings using the one or more feature extraction models, comprises:
extracting, by the one or more hardware processors, one or more audio segments from one or more passphrases spoken by one or more users during the one or more videos;
processing, by the one or more hardware processors, the extracted one or more audio segments to analyze one or more audio characteristics of the one or more audio segments comprising voice patterns, speech features, and vocal signatures, using a deep representation learning based feature extraction model by:
receiving, by the one or more hardware processors, the one or more audio segments extracted from the one or more passphrases spoken by one or more users during the one or more videos;
pre-processing, by the one or more hardware processors, the one or more audio segments by converting raw audio waveform into spectral data comprising at least one of:
mel-frequency cepstral coefficients or spectrograms;
applying, by the one or more hardware processors, the spectral data to extract one or more hierarchical audio features through a neural network encoder, wherein the one or more hierarchical audio features comprise at least one of: low-level audio features comprising pitch, tone, and frequency patterns, mid-level audio features comprising phoneme characteristics, speech rhythm, and cadence, and high-level audio features comprising speaker-specific vocal signatures, and unique voice patterns; and
mapping, by the one or more hardware processors, the extracted one or more hierarchical audio features into a shared embedding space where similar voices are positioned in relative proximity; and
outputting, by the one or more hardware processors, a pre-determined size of element floating point vector indicating a unique signature of the one or more audio segments.

6. The ML-based method of claim 1, wherein determining whether the one or more users are the one or more live users based on the generated one or more first embeddings, using the ML-based classifier, comprises:
receiving, by the one or more hardware processors, the one or more image-based embeddings from the contrastive language-image pre-training based feature extraction model;
applying, by the one or more hardware processors, the one or more image-based embeddings into the ML-based classifier that is trained to differentiate the one or more users from the one or more presentation attacks;
analyzing, by the one or more hardware processors, the one or more image-based embeddings for liveness indicators comprising at least one of: skin texture patterns compliance with live human skin, natural facial micro-movements and expressions, light reflection patterns on face and eyes, and depth and dimensionality cues, using the ML-based classifier; and
classifying the analyzed one or more image-based embeddings against one or more known attack vectors comprising at least one of: printed photographs of people, photos displayed on the one or more edge devices, physical masks, and three dimensional profiles, to determine whether the one or more users are the one or more live users, using the ML-based classifier.

7. The ML-based method of claim 1, wherein determining whether the obtained one or more videos are authentic based on the deepfake detection, using the ML-based classifier, comprises:
receiving, by the one or more hardware processors, the one or more image-based embeddings and the one or more audio-based embeddings, from the contrastive language-image pre-training based feature extraction model and the deep representation learning based feature extraction model;
applying, by the one or more hardware processors, the one or more image-based embeddings and the one or more audio-based embeddings, into the ML-based classifier that is trained to differentiate the one or more users from the one or more presentation attacks and to authenticate the one or more videos;
analyzing, by the one or more hardware processors, at least one of:
the one or more image-based embeddings for liveness indicators comprising at least one of: skin texture patterns compliance with live human skin, natural facial micro-movements and expressions, light reflection patterns on face and eyes, and depth and dimensionality cues, using the trained ML-based classifier; and
the one or more audio-based embeddings for authenticity indicators comprising at least one of: natural speech patterns and intonations, voice consistency throughout the one or more passphrases, and absence of synthetic audio artifacts, using the trained ML-based classifier; and
determining, by the one or more hardware processors, an authenticity of the obtained one or more videos based on the analyzed one or more image-based embeddings and one or more audio-based embeddings.

8. The ML-based method of claim 1, further comprising:
triggering, by the one or more hardware processors, image-based liveness detection immediately upon generation of the one or more image-based embeddings;
triggering, by the one or more hardware processors, audio-based deepfake detection immediately upon generation of the one or more audio-based embeddings;
executing, by the one or more hardware processors, the image-based liveness detection and the audio-based deepfake detection, asynchronously in an execution pipeline; and
eliminating, by the one or more hardware processors, sequential processing delays to maintain real-time latency thresholds.

9. The ML-based method of claim 1, further comprising streaming, by the one or more hardware processors, one or more biometric data packets comprising one or more audio frames and one or more image frames to an on-device inference engine in real-time, wherein the on-device inference engine is configured to perform incremental embedding updates and continuous liveness scoring to provide a preliminary validation state before the one or more users have completed speaking the one or more passphrases.

10. The ML-based method of claim 1, further comprising:
initializing, by the one or more hardware processors, one or more ML-based classifiers in device memory upon initiation of capturing of the one or more videos;
passing, by the one or more hardware processors, the one or more first embeddings between the one or more ML-based classifiers using a shared-memory architecture; and
eliminating, by the one or more hardware processors, data copying overhead and mitigating processing latency.

11. The ML-based method of claim 1, further comprising:
detecting, by the one or more hardware processors, an initiation of the one or more high-risk transactions by one or more previously validated users on the one or more edge devices;
obtaining, by the one or more hardware processors, one or more re-authentication inputs associated with the one or more users through the one or more image capturing units of the one or more edge devices;
generating, by the one or more hardware processors, one or more re-authentication embeddings from the one or more re-authentication inputs using the one or more feature extraction models executing on the one or more edge devices;
comparing, by the one or more hardware processors, the generated one or more re-authentication embeddings against the one or more first embeddings retrieved from the secured local storage of the one or more edge devices, wherein comparing is performed entirely on the one or more edge devices without transmitting at least one of: biometric data and embeddings to an external server; and
validating, by the one or more hardware processors, the one or more users to perform a transaction associated with the one or more high-risk transactions when the one or more re-authentication embeddings match the one or more first embeddings within a configurable similarity threshold.

12. The ML-based method of claim 1, wherein:
the one or more first inputs comprise the one or more videos of the one or more users speaking the one or more passphrases, captured through the one or more image capturing units of the one or more edge devices; and
the one or more first embeddings comprise the one or more image-based embeddings generated from the one or more still frames extracted from the one or more videos, and one or more audio-based embeddings generated from the one or more audio segments extracted from the one or more passphrases spoken by the one or more users during the one or more videos.

13. The ML-based method of claim 1, wherein performing at least one of: the liveness detection and the deepfake detection, further comprises:
initializing, by the one or more hardware processors, the one or more ML-based classifiers in device memory of the one or more edge devices upon initiation of obtaining the one or more first inputs;
triggering, by the one or more hardware processors, the liveness detection immediately upon generation of the one or more image-based embeddings from the one or more first inputs;
triggering, by the one or more hardware processors, the deepfake detection immediately upon generation of the one or more audio-based embeddings from the one or more first inputs;
executing, by the one or more hardware processors, the liveness detection and the deepfake detection concurrently and asynchronously in an execution pipeline; and
passing, by the one or more hardware processors, the one or more first embeddings between the one or more ML-based classifiers using the shared-memory architecture, wherein the one or more ML-based classifiers access the one or more first embeddings from a common memory location without copying the one or more first embeddings to separate memory locations, for eliminating data copying overhead and reducing processing latency.

14. The ML-based method of claim 1, further comprising:
streaming, by the one or more hardware processors, the one or more biometric data packets comprising the one or more audio frames and the one or more image frames to the on-device inference engine in real-time as the one or more first inputs are being obtained;
performing, by the one or more hardware processors, the incremental embedding updates by progressively refining the one or more first embeddings as each of the one or more audio frames and one or more image frames is received by the on-device inference engine; and
generating, by the one or more hardware processors, the preliminary validation state based on the continuous liveness scoring updated with each received frame, wherein the preliminary validation state is produced before the one or more users have completed providing the one or more first inputs.

15. A machine learning (ML)-based system for optimized real-time identity verification of one or more users on one or more edge devices, the ML-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
an input obtaining subsystem configured to obtain one or more first inputs associated with the one or more users from one or more image capturing units of the one or more edge devices, using a software development kit configuring on the one or more edge devices;
an embeddings generating subsystem configured to generate one or more first embeddings from the one or more first inputs associated with the one or more users, using one or more feature extraction models executing on the one or more edge devices, wherein raw biometric data from which the one or more first embeddings are generated is processed entirely on the one or more edge devices and is not transmitted externally from the one or more edge devices;
a liveness determining subsystem configured to perform at least one of: liveness detection and deepfake detection, on the one or more edge devices based on the generated one or more first embeddings, using a ML-based classifier executing on the one or more edge devices; and
an embeddings storing subsystem configured to store the generated one or more first embeddings in a secured local storage of the one or more edge devices.

16. The ML-based system of claim 15, further comprising a user validating subsystem configured to:
analyze whether the one or more users initiate the one or more high-risk transactions upon validation of the one or more users into the ML-based system;
request one or more second inputs associated with the one or more users through the one or more image capturing units of the one or more edge devices, using the software development kit for re-authentication;
generate one or more third embeddings from the one or more second inputs associated with the one or more users, using the one or more feature extraction models;
compare the generated one or more third embeddings with the generated one or more first embeddings stored in the secured local storage of the one or more edge devices;
compare the generated one or more third embeddings with the generated one or more first embeddings; and
validate the one or more users to perform the transaction data associated with the one or more high-risk transactions when the generated one or more third embeddings are matched with the generated one or more first embeddings.

17. The ML-based system of claim 15, wherein in generating the one or more first embeddings comprising one or more audio-based embeddings using the one or more feature extraction models, the embeddings generating subsystem is further configured to:
extract one or more audio segments from the one or more passphrases spoken by the one or more users during one or more videos;
process the extracted one or more audio segments to analyze one or more audio characteristics of the one or more audio segments comprising voice patterns, speech features, and vocal signatures, using a deep representation learning based feature extraction model by:
receiving the one or more audio segments extracted from the one or more passphrases spoken by one or more users during the one or more videos;
pre-processing the one or more audio segments by converting raw audio waveform into spectral data comprising at least one of: mel-frequency cepstral coefficients or spectrograms;
applying the spectral data to extract one or more hierarchical audio features through a neural network encoder, wherein the one or more hierarchical audio features comprise at least one of: low-level audio features comprising pitch, tone, and frequency patterns, mid-level audio features comprising phoneme characteristics, speech rhythm, and cadence, and high-level audio features comprising speaker-specific vocal signatures, and unique voice patterns; and
mapping the extracted one or more hierarchical audio features into a shared embedding space where similar voices are positioned in relative proximity; and
output a pre-determined size of element floating point vector indicating a unique signature of the one or more audio segments.

18. The ML-based system of claim 15, wherein in determining whether the obtained one or more videos are authentic based on the deepfake detection, using the ML-based classifier, the liveness determining subsystem is further configured to:
receive one or more image-based embeddings and one or more audio-based embeddings, from the contrastive language-image pre-training based feature extraction model and the deep representation learning based feature extraction model;
apply the one or more image-based embeddings and the one or more audio-based embeddings, into the ML-based classifier that is trained to differentiate the one or more users from the one or more presentation attacks and to authenticate the one or more videos;
analyze at least one of:
the one or more image-based embeddings for liveness indicators comprising at least one of: skin texture patterns compliance with live human skin, natural facial micro-movements and expressions, light reflection patterns on face and eyes, and depth and dimensionality cues, using the trained ML-based classifier; and
the one or more audio-based embeddings for authenticity indicators comprising at least one of: natural speech patterns and intonations, voice consistency throughout the one or more passphrases, and absence of synthetic audio artifacts, using the trained ML-based classifier; and
determine an authenticity of the obtained one or more videos based on the analyzed one or more image-based embeddings and one or more audio-based embeddings.

19. The ML-based system of claim 15, further comprising a data comparing subsystem configured to perform cosine similarity matching between the generated one or more first embeddings and one or more second embeddings, by:
receiving a pre-determined size of an element floating point vector associated with the one or more still frames of the one or more image-based embeddings;
receive a pre-determined size of the element floating point vector indicating the at least one image of the one or more pre-authorized identities;
analyze the one or more image-based embeddings of the one or more first inputs and the one or more second embeddings of the one or more pre-authorized identities, as one or more vectors in a multi-dimensional space;
compute one or more dot products of the one or more vectors;
compute magnitude of each vector of the one or more vectors;
compute the cosine similarity score by dividing the one or more dot products of the one or more vectors associated with the generated one or more first embeddings and the one or more vectors associated with the one or more second embeddings of the one or more pre-authorized identities, by the product of the magnitudes of both vectors; and
compare the cosine similarity score against the user specified threshold value, to validate the one or more users.

20. A non-transitory computer-readable storage medium having instructions stored therein that when executed by one or more hardware processors, cause the one or more hardware processors to execute operations of:
obtaining one or more first inputs associated with one or more users from one or more image capturing units of one or more edge devices, using a software development kit configuring on the one or more edge devices;
generating one or more first embeddings from the one or more first inputs associated with the one or more users, using one or more feature extraction models executing on the one or more edge devices, wherein raw biometric data from which the one or more first embeddings are generated is processed entirely on the one or more edge devices and is not transmitted externally from the one or more edge devices;
performing at least one of: liveness detection and deepfake detection on the one or more edge devices based on the generated one or more first embeddings, using a ML-based classifier executing on the one or more edge devices; and
storing the generated one or more first embeddings in a secured local storage of the one or more edge devices.
